(19) United States
(12) Patent Application Publication
(10) Pub. No.: US 2018/0295347 A1
(43) Pub. Date: Oct. 11, 2018

(54) APPARATUS FOR MEASURING THREE-DIMENSIONAL POSITION OF OBJECT

(71) Applicants: DENSO CORPORATION, Kariya-city (JP); NAGOYA INSTITUTE OF TECHNOLOGY, Nagoya (JP)

(72) Inventors: Kazuhisa Ishimaru, Nishio-city (JP); Noriaki Shirai, Kariya-city (JP); Jun Sato, Nagoya (JP); Fumihiko Sakaue, Nagoya (JP)

(21) Appl. No.: 15/944,060

(22) Filed: Apr. 3, 2018

(30) Foreign Application Priority Data
Apr. 5, 2017 (JP) 2017-075014

(51) Int. Cl. H04N 13/246; H04N 13/271

(52) U.S. Cl. CPC H04N 13/246; H04N 2013/0081; H04N 13/271

(57) ABSTRACT

In a position measuring apparatus, a correspondence point detector detects, for each set of images at a respective one of time instants, correspondence points from the respective images of the set, where the correspondence points are points on respective image planes representing the same three-dimensional position. A projection point calculator calculates a projection point of each of the correspondence points detected at the respective time instants onto each of a plurality of common planes set at different depthwise positions in a world coordinate system using preset camera parameters. A reconstruction point calculator calculates a point at which distances to a plurality of rays each connecting the projection points of the correspondence point on a respective one of the image planes onto the plurality of common planes are minimized, as a reconstruction point representing a three-dimensional position of the correspondence point.

### CROSS-REFERENCE TO RELATED APPLICATION

This application is based on and claims the benefit of priority from earlier Japanese Patent Application No. 2017-75014 filed Apr. 5, 2017, the description of which is incorporated herein by reference.

### BACKGROUND

### Technical Field

This disclosure relates to an apparatus for measuring a three-dimensional position of an object using images acquired from a plurality of cameras.

### Related Art

A known apparatus for measuring a three-dimensional position of an object using images acquired from a plurality of cameras is based on a single focus camera model in which light entering each camera focuses in the center of a lens of the camera.

However, the measurement accuracy of the single focus camera model may significantly decrease in the presence of an object, such as a front windshield, that can bend the light between the camera and an object of interest.

Instead of using the single focus camera model described by linear mapping, use of a single focus camera model described by non-linear mapping has been proposed in, for example, Japanese Patent Application Laid-Open Publication No. 2012-75060.

In the single focus camera models, two planes are assumed for each camera, where an object of interest lies between the two planes. Internal parameters representing non-linear mapping on the two planes and external parameters representing a positional relationship between the cameras are defined. For each camera, projection points of a point on an image acquired from the camera onto the two planes are acquired using the internal parameters, and then a back-projected ray connecting the two projection points is acquired. A positional relationship between the back-projected rays connecting the projection points of the same point on the images acquired from the respective cameras is adjusted using the external parameters, thereby acquiring an intersection point of these back-projected rays as a reconstruction point.

For these single focus camera models, it is necessary to define the internal and external parameters. To calibrate the cameras, both the internal and external parameters have to be adjusted in conjunction with each other, which is burdensome on the user.

In addition, the apparatus disclosed in Japanese Patent Application Laid-Open Publication No. 2012-75060 requires specialized equipment for calibrating the cameras. Thus, it is unable to dynamically accommodate changes in positional relationship between the cameras caused by vibration or the like during actual use of the on-vehicle camera or the like.

In view of the above, it is desired to provide an apparatus for measuring a three-dimensional position of an object using images acquired from a plurality of cameras, with capability of more simply calibrating the cameras.

### SUMMARY

In accordance with an exemplary embodiment of the present disclosure, there is provided a position measuring apparatus including an image acquirer, a correspondence point detector, a projection point calculator, and a reconstruction point calculator.

The image acquirer is configured to acquire a plurality of sets of images at a plurality of respective time instants, where each set of images are simultaneously captured at a respective one of the plurality of time instants from different perspectives so as to include the same captured area.

The correspondence point detector is configured to detect, for each set of images at a respective one of the time instants, correspondence points from the respective images of the set, where the correspondence points are points on respective image planes representing the same three-dimensional position.

The projection point calculator is configured to calculate a projection point of each of the correspondence points detected at the respective time instants onto each of a plurality of common planes set at different depthwise positions in a world coordinate system using preset camera parameters. The camera parameters represent a correspondence relationship to acquire non-linear mapping from each image plane to each common plane for each of all combinations of one of the image planes for each set of images captured at a respective one of the time instants and the plurality of common planes.

The reconstruction point calculator is configured to calculate a point at which distances to a plurality of rays each connecting the projection points of the correspondence point on a respective one of the image planes onto the plurality of common planes are minimized, as a reconstruction point representing a three-dimensional position of the correspondence point.

Unlike the conventional single focus camera models with a pair of projection planes prepared individually for each camera, this configuration eliminates a need for the external parameters describing a positional relationship between the cameras, which can reduce the number of parameters required to calculate the reconstruction points. Further, this configuration only has to deal with the camera parameters corresponding to the internal parameters in the conventional single focus camera models, which can simplify calibration of the camera parameters. This can improve the calculation accuracy of the reconstruction points.

The reconstruction points are calculated using the images at a plurality of time instants, which can improve the calculation accuracy of the reconstruction points as compared to the configuration where the reconstruction points are calculated using the images at a single time instant.

### BRIEF DESCRIPTION OF THE DRAWINGS

FIG. 1A is a block diagram of a position measuring apparatus in accordance with one embodiment of the present disclosure;

FIG. 1B is a functional block diagram of a processing unit shown in FIG. 1A;

FIG. 2 is an illustration for a non-single focus camera model;

FIG. 3 is an illustration for setting initial values of camera parameters and a measurement environment used in experiments;

FIG. 4 is an example of a test pattern;

FIG. 5 is a flowchart of distance calculation processing;

FIG. 6 is an illustration for reconstruction points and reprojection points;

FIG. 7 is a graph illustrating an experimental result of a relationship between the number of time instants T that is the number of sets of captured images used for position measurement and mean squared error for reconstruction points; and

FIG. 8 is a graph for illustrating an experimental result of a relationship between coefficient α of regularization terms and mean squared error for reconstruction points.

### DESCRIPTION OF SPECIFIC EMBODIMENTS

Hereinafter, exemplary embodiments of the present disclosure will be described in detail with reference to the accompanying drawings, in which like reference numerals refer to like or similar elements regardless of reference numerals and duplicated description thereof will be omitted.

### 1. Configuration

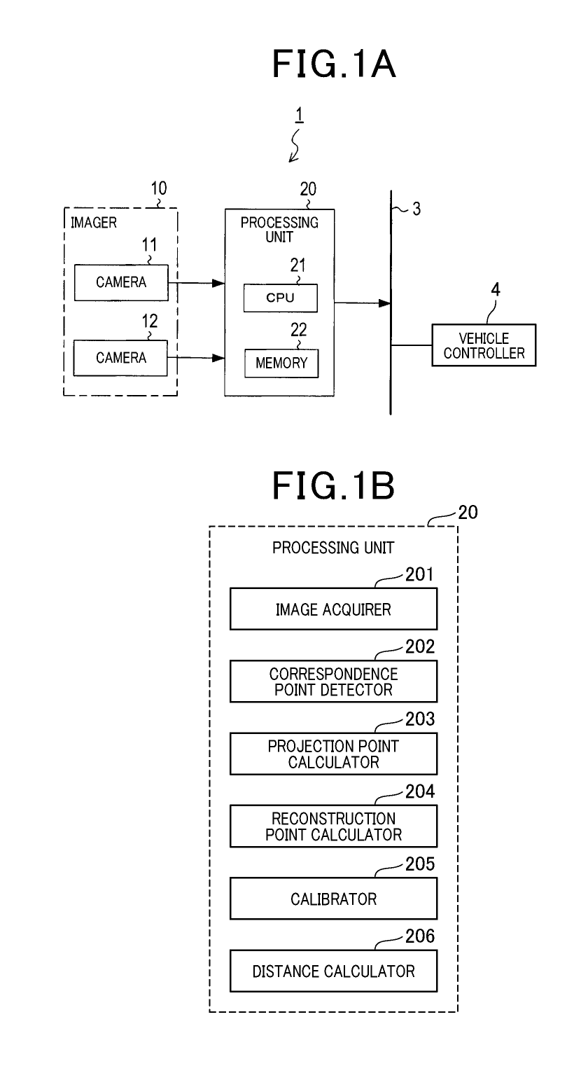

A position measuring apparatus 1 shown in FIG. 1A uses a plurality of captured images to measure a three-dimensional distance to each point on each image.

The position measuring apparatus 1 is mounted in a vehicle, such as a passenger car, and includes an imager 10 and a processing unit 20. The position measuring apparatus 1 is connected to other on-vehicle devices including a vehicle controller 4 via an on-vehicle network 3. The vehicle controller 4 performs various processing (e.g., automated braking, automated steering, alert output and the like) based on a distance to an object appearing in the images.

The imager 10 includes a plurality of cameras forming a camera array that is a grid of cameras. For example, a parallel stereoscopic camera having a pair of on-vehicle cameras arranged in a horizontal direction is one type of camera array. In the following, it is assumed that the imager 10 includes a pair of cameras 11, 12 forming a parallel stereoscopic camera. It should be noted that the number of cameras is not limited to two, but may be greater than two. The cameras 11, 12 are disposed in a passenger compartment to capture images of a forward area in the travel direction of the vehicle including the same captured area through a front windshield. That is, the imager 10 acquires a plurality of images simultaneously captured from different perspectives so as to include the same captured area and feeds the images to the processing unit 20.

The processing unit 20 may be formed of at least one microcomputer including a central processing unit (CPU) 21 and semiconductor memories (collectively indicated by memory 22 in FIG. 1A), such as a random access memory (RAM), a read only memory (ROM), and a flash memory. Various functions of the processing unit 20 may be implemented by the CPU 21 executing computer programs stored in a non-transitory, tangible computer-readable storage medium. In the present embodiment, the memory 22 corresponds to the non-transitory, tangible computer-readable storage medium. Various processes corresponding to the programs are implemented by the programs being executed.

The processing unit 20 implements at least distance calculation processing described later in detail as a function implemented by the CPU 21 executing the computer programs stored in the non-transitory, tangible computer-readable storage medium. Various functions of the processing unit 20 may be realized not only in software, but also in hardware, for example, in logic circuitry, analog circuitry, or combinations thereof.

Referring to FIG. 1B, the processing unit 20 includes, as functional blocks, an image acquirer 201 responsible for execution of step S110 of the distance calculation processing, a correspondence point detector 202 responsible for execution of step S120, a projection point calculator 203 responsible for execution of step S150, a reconstruction point calculator 204 responsible for execution of steps S160-S180, a calibrator 205 responsible for execution of step S210, and a distance calculator 206 responsible for execution of step S220.

### 2. Camera Model

A non-single focus camera model based on which distance calculation processing is performed will now be described. The non-single focus camera model is configured to accurately describe a ray path even in a situation where the ray is refracted by a front windshield or the like disposed in front of the cameras. The camera model is set individually each time the cameras simultaneously capture an image. In the following, the camera model set at a specific time instant will be described for illustration purposes.

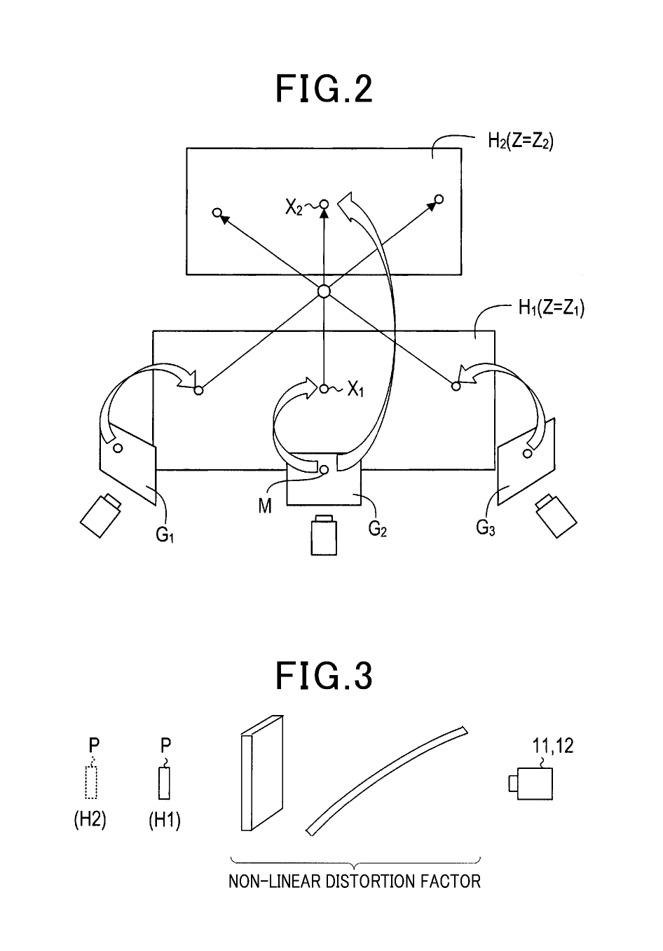

In this camera model, as shown in FIG. 2, a three-dimensional point captured by a plurality of cameras is projected onto two two-dimensional (2D) image planes. FIG. 2 illustrates use of three cameras. It should be noted that the number of cameras is not limited to three, but may be any number greater than one. Two common planes H1, H2, as projection planes, are spaced apart from each other with an object of interest therebetween. For each camera, non-linear mapping is defined for projection from the image plane Gn of the camera onto each common plane Hj where n=1, 2, 3 and j=1, 2.

That is, in the present embodiment, unlike the conventional single focus camera models where a pair of two projection planes are defined individually for each camera, only one pair of two planes H1, H2 common to the plurality of cameras are defined. Use of these common planes H1, H2 can eliminate the need for the external parameters for defining a positional relationship between the cameras.

In a world coordinate system with X-, Y-, and Z-coordinates, the common plane H1, H2 are defined by Z=Z1 and Z=Z2, respectively, where Z1 and Z2 are different fixed values in a depthwise direction. A point Xj on the common plane Hj is expressed by the following equation (1), where x1j is an X-coordinate (or a horizontal coordinate) and x2j is a Y-coordinate (or a vertical coordinate).

Xⱼ=[x₁ⱼ,x₂ⱼ,Zⱼ]^{T} (1)

In transformation of an image point M on the image plane Gn of the camera to a point on each common plane H1, H2, the Z-coordinate Zj may be ignored because it is a fixed value. The non-linear mapping of an image point M=(m1, m2) on the image plane Gn to a horizontal coordinate x1j or a vertical coordinate x2j on each common plane Hj is defined by Kth-order polynomials as shown in the following equation (2). In the equation (2), m1 is a horizontal coordinate on the image plane Gn, m2 is a vertical coordinate on the image plane Gn, and akl are coefficients used in the transformation. These parameters define the camera model. The coefficients akl are individually defined for each of the horizontal coordinate x11 and the vertical coordinate x21 on the common plane H1 and the horizontal coordinate x12 and the vertical coordinate x22 on the common plane H2.

$${x}_{ij} = \frac{1}{λ} {\sum }_{k = 0}^{K} {{\sum }_{l = 0}}^{K - k} {a}_{kl} {m}_{1}^{k} {m}_{2}^{l} ( i = 1 , 2 ; j = 1 , 2 ) \\ λ = {\sum }_{k = 0}^{1} {\sum }_{l = 0}^{1 - k} {a}_{kl} {m}_{1}^{k} {m}_{2}^{l} \qquad ( 2 )$$

This transformation is defined by a combination of the Kth-order polynomial based non-linear transformation and the plane projective transformation. In the case of K=1, the above transformation is equivalent to the plane projective transformation. Combining the non-linear Kth-order polynomials and the plane projective transformation enables properly expressing the rotation or the like of each camera.

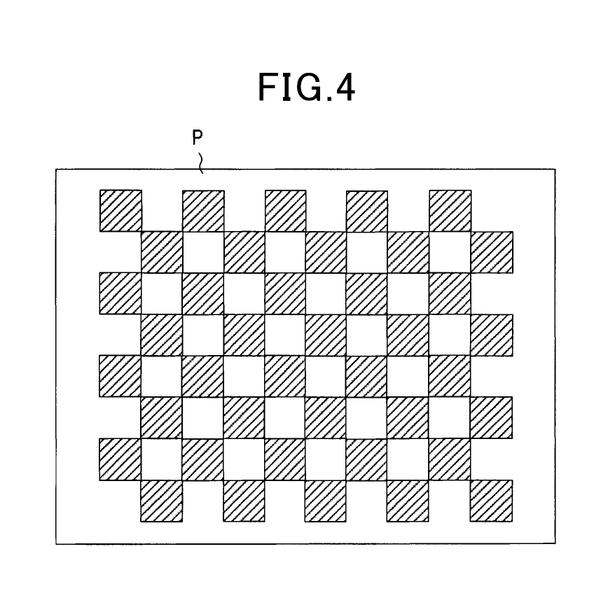

An initial value of each camera parameter akl is set to a value pre-determined by experiments or the like. Thereafter, the value of each camera parameter akl is updated each time the distance calculation processing is performed. To determine the initial value of each camera parameter akl, as shown in FIG. 3, the cameras 11, 12 are disposed with respect to a non-linear distortion factor, such as a front windshield, for alignment during actual use of the cameras, and then capture an image of a test pattern P disposed at a position corresponding to a respective one of the common planes H1, H2 through the non-linear distortion factor. A grid pattern as shown in FIG. 4 may be used as the test pattern P. Correspondence points on the image planes Gn of the cameras 11, 12 are detected from a captured image result of the cameras. Camera parameters akl for each camera are determined using the equation (2) from a relationship between a position of the correspondence point on the image plane Gn, that is, (m1, m2), a known and actual position of the correspondence point on the test pattern P as disposed at the position of the common plane H1, that is, (x11, x21), and a known and actual position of the correspondence point on the test pattern P as disposed at the position of the common plane H2, that is, (x12, x22).

The transformation in the case of K=2 is expressed by the equation (3). This equation expresses projection onto any one of the common planes H1, H2. For illustration purposes, the suffix j specifying one of the common planes H1, H2 is omitted. The camera parameters akl are used in the transformation to the horizontal coordinate x1, and the camera parameters bkl are used in the transformation to the vertical coordinate x2.

$$( \begin{matrix}{x}_{1} \\ {x}_{2}\end{matrix} ) = \frac{1}{λ} ( \begin{matrix}{a}_{20} & {a}_{11} & {a}_{02} & {a}_{10} & {a}_{01} & {a}_{00} \\ {b}_{20} & {b}_{11} & {b}_{02} & {b}_{10} & {b}_{01} & {b}_{00}\end{matrix} ) ( \begin{matrix}{m}_{1}^{2} \\ {m}_{1} \times {m}_{2} \\ {m}_{2}^{2} \\ {m}_{1} \\ {m}_{2} \\ 1\end{matrix} ) \\ λ = {c}_{10} {m}_{1} + {c}_{01} {m}_{2} + {c}_{00} \qquad ( 3 )$$

### 3. Distance Calculation Processing

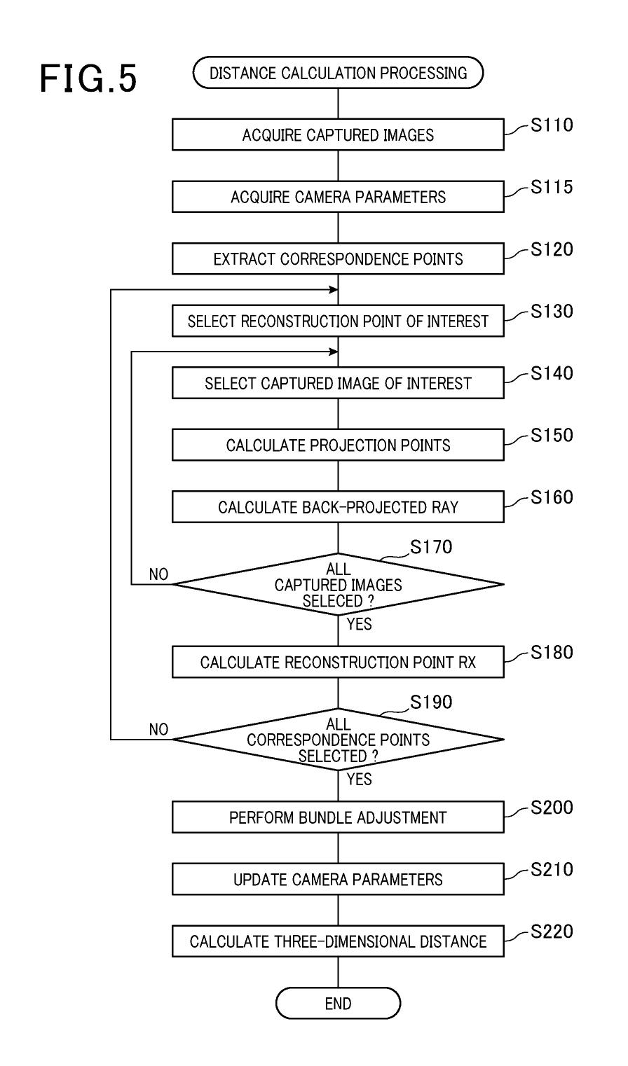

Distance calculation processing performed by the CPU 21 of the processing unit 20 will now be described with reference to a flowchart of FIG. 5. This processing is performed iteratively every predetermined time interval.

At least a program for the distance calculation processing and initial values of the camera parameters akl predetermined by experiments are stored in the memory 22. Four sets of camera parameters akl are required to calculate x11, x21, x12, and x22 for each camera. In the present embodiment where two cameras 11, 12 are used, a total of eight sets of camera parameters are prepared. Being expressed by the equation (3), two sets of camera parameters are required to calculate (x1j, x2j) for each camera. Therefore, a total of four sets of camera parameters have to be prepared for the two cameras.

Upon initiating the distance calculation processing, the processing unit 20, at step S110, acquires images captured at the same time instant from the cameras 11, 12 forming the imager 10. The processing unit 20 then stores the captured images in the memory 22 and acquires captured images previously stored in the memory 22. In this processing, for example, the processing unit 20 acquires the first to seventh previous captured images from the memory 22, and performs this processing using these previously stored images and the last captured images, that is, the captured images at a total of eight time instants.

At step S120, the processing unit 20 extracts correspondence points deemed to represent the same three-dimensional position from each of the captured image at each time instant acquired from the cameras 11, 12. To extract the correspondence points, the processing unit 20 acquires image features at respective points on each captured image and extract points similar in the image features as the correspondence points using a well-known technique. In the following, the number of correspondence points is W that is a positive integer.

At step S130, the processing unit 20 selects one of the correspondence points extracted at step S120 as a point of interest to be reconstructed. At step S140, the processing unit 20 selects one of the captured images at each time instant acquired from the cameras 11, 12 as an image of interest.

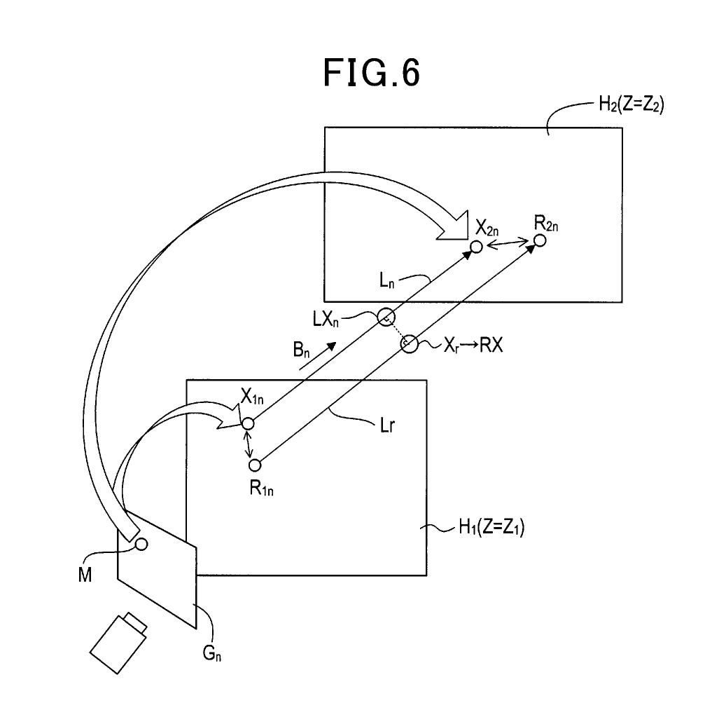

At step S150, the processing unit 20 uses the camera parameters akl stored in the memory 22 to calculate a projection point Xj=(x1j, x2j) that is the point of interest to be reconstructed M=(m1, m2) on the image plane Gn of the image of interest projected onto each common plane Hj (j=1, 2) according to the equation (2), as shown in FIG. 6.

At step S160, the processing unit 20 calculates a three-dimensional line, referred to as a back-projected ray L, connecting both the two projection points X1, X2 acquired at step S150, specified by three-dimensional coordinates X1=(x11, x21, Z1), X2=(x12, x22, Z2), respectively. The projection point X1 is the point of interest to be reconstructed M on the image plane Gn projected onto the common plane H1. The projection point X2 is the point of interest to be reconstructed M on the image plane Gn projected onto the common plane H2.

At step S170, the processing unit 20 determines whether or not the operations at steps S140-S160 have been performed for all the respective captured images from the cameras 11, 12. If the answer is “YES” at step S170, then the process flow proceeds to step S180. If the answer is “NO” at step S170, then the process flow returns to step S140 to repeat the operations at steps S140-S150.

At step S180, the processing unit 20 calculates, for the point of interest to be reconstructed M selected at step S130, a reconstruction point RX representing a three-dimensional position of the point of interest to be reconstructed M using a total of N back-projected rays L calculated for the respective cameras. Without measurement errors, the three-dimensional position of the point of interest to be reconstructed M would reside at an intersection point of the N back-projected rays L. In practice, however, there may be no intersection point of the N back-projected rays L due to the presence of the measurement errors. Therefore, the processing unit 20 calculates a three-dimensional point with a minimum sum of squared distances to the N back-projected rays L according to the equation (4), as the reconstruction point RX.

$$RX = {arg min}_{Xr} {\sum }_{n = 1}^{N} {‖ {X}_{r} - {LX}_{n} ‖}^{2} \qquad ( 4 )$$

Referring to FIG. 6, a ray vector Bn is a unit vector in a direction of the back-projected ray Ln passing through the projection points Xjn of the point of interest to be reconstructed M on the image plane Gn for the nth camera onto the common planes Hj (j=1, 2). To calculate a distance from an arbitrary reconstruction point candidate Xr in a three-dimensional space to the back-projected ray L, the processing unit 20 uses the equation (5) to calculate an LXn that is a projection point of the reconstruction point candidate Xr onto the back-projected ray Ln. The ray vector Bn is expressed by the equation (6). The reconstruction point Rx is a reconstruction point candidate Xr with minimal distances to the back-projected rays Ln for all the respective cameras, as shown in the equation (4).

$$\begin{matrix}{LX}_{n} = {X}_{1 n} + {B}_{n} {B}_{n}^{T} ( {X}_{r} - {X}_{1 n} ) & ( 5 ) \\ {B}_{n} = \frac{( {X}_{2 n} - {X}_{1 n} )}{‖ {X}_{2 n} - {X}_{1 n} ‖} & ( 6 )\end{matrix}$$

At step S190, the processing unit 20 determines whether or not the operations at steps S130-S180 have been performed for all the correspondence points extracted at step S120. If the answer is “YES”, then the process flow proceeds to step S200. If the answer is “NO”, then the process flow returns to step S130 to repeat the operations at steps S130-S180.

At step S200, the processing unit 20 calibrates a set of reconstruction points {RX} consisting of W reconstruction points calculated at step S180 and a set of camera parameters {A} consisting of eight camera parameters used to calculate the set of reconstruction points {RX}. At step S210, the processing unit 20 updates the camera parameters stores in the memory 22 with the calibrated camera parameter set {A}.

More specifically, the processing unit 20 calibrates, for each of the W reconstruction points, a reprojection error Ew where w=1, 2, . . . , W. The reprojection error Ew for the wth reconstruction point is calculated by acquiring the reprojection points Rjn of the wth reconstruction point RX onto the respective common planes Hj along the ray vector Bn (see FIG. 6) and using the following equation (7). That is, the reprojection error Ew for the wth reconstruction point is a sum of squared distances between the projection point Xjnt and the reprojection point Rjnt over all (t, n, j), where t, n, j are positive integers such that 1≤t≤T, 1≤n≤N, and 1≤j≤2. T is the number of time instants, N the number of the cameras, and j the number of the common plane. The reprojection error Ew is an integral of squares of distance between the projection point and the reprojection point over all the reprojection points acquired at the different time instants. Thus, the reprojection error Ew is a distance term representing squared distances for the plurality of back-projected ray rays.

$${E}_{w} = {\sum }_{t = 1}^{T} {\sum }_{n = 1}^{N} {\sum }_{j = 1}^{2} {‖ {X}_{jnt} - {R}_{jnt} ‖}^{2} \qquad ( 7 )$$

A parameter term Rw, as expressed by the equation (8), is also taken into account in a bundle adjustment to limit changes with the time sequence in the camera parameters akl.

$${R}_{w} = α {\sum }_{t = 1}^{T} {\sum }_{k = 0}^{K} {\sum }_{l = 0}^{K - k} {\sum }_{i = 1}^{3} ( {a}_{kl}^{ijt} - {a}_{kl}^{ij ( t + l )} ) \qquad ( 8 )$$

A position of each correspondence point, as shown in the equation (3), includes higher order terms with a degree of m equal to or higher than two and lower order terms with a degree of m less than two. In the equation (8), the coefficients α are not necessarily all equal. In the present embodiment, the coefficients α of the higher order terms are equal and predetermined. The coefficients α of the lower order terms are less than the coefficients of the higher order terms. In the present embodiment, for example, α=10000 for the higher order terms and α=0 for the lower order terms.

Variations in the camera parameters due to non-linear distortions caused by a refractor, such as a front windshield, are more liable to appear in the higher order terms than in the lower terms. Variations in the camera parameters caused by motion of the cameras, such as translation or rotation, are more liable to appear in the lower order terms than in the higher order terms. Therefore, in the present embodiment, taking into account the non-linear distortions caused by the refractor, and to reduce effects of the motion of the cameras, the coefficients of the higher order terms are set greater than the coefficients of the lower order terms.

In turn, a bundle adjustment is performed, where the set of reconstruction points {RX} and the set of camera parameters {A} are adjusted such that a cost is minimized. As shown in the equation (9), the cost is a sum of the reprojection errors Ew for the all the respective reconstruction points belonging to the set of reconstruction points {RX} and the parameter terms Rw representing the magnitude of changes in the camera parameters.

That is, in the bundle adjustment, each time the camera parameters {A} are calibrated, the cost is iteratively acquired using the set of calibrated camera parameters {A}. This bundle adjustment may be performed using a well-known technique, and description thereof is therefore omitted.

$$\{ \{ A \} , \{ RX \} \} = arg min {\sum }_{w = 1}^{W} ( {E}_{w} + {R}_{w} ) \qquad ( 9 )$$

At step S220, the processing unit 20 uses the set of reconstruction points {RX} calculated using the camera parameters {A} calibrated at step S210 to generate distance information representing three-dimensional distances to various objects in the image and feeds the distance information to each on-vehicle device via the on-vehicle network 3. Thereafter, the process flow ends.

### 4. Experiment 1

A result of three-dimensional distance measurement that was performed using the position measuring apparatus 1 set forth above will now be described. In this experiment, a mean squared error (MSE) with respect to actual three-dimensional points was measured while varying the number of captured image sets acquired at different time instants utilized in this processing, that is, the number of time instants for the captured images.

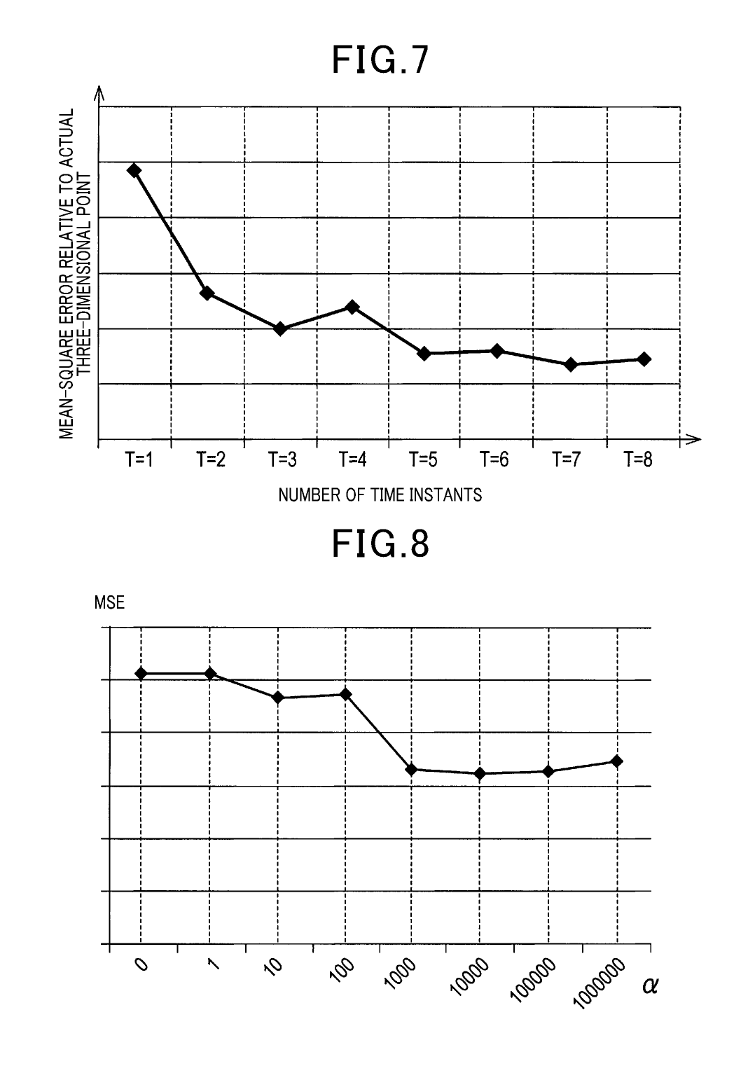

As can be seen from FIG. 7, the MSE tends to decrease as the number of time instants T for the captured images increases. Particularly, the MSE significantly decreases when the number of time instants T is greater than one as compared to when the number of time instants T is one.

### 5. Experiment 2

The mean squared error (MSE) with respect to actual three-dimensional points was measured while varying the coefficient α of the regularization term shown in the equation (8). In this experiment, the coefficient α for the higher order terms is varied while the coefficient α for the lower order terms is zero. That is, as can be seen from FIG. 8, weighting the higher order terms with a large weight, i.e., α≥1000, and weighting the lower order terms with a null weight can reduce the MSE as compared to when there is no regularization term.

This result shows that the assumption that the higher order terms do not significantly change with the time sequence even when the cameras are moving is valid. Therefore, it makes sense to set the cost for variations in the higher order terms.

However, an excessively large a may lead to a relatively low weight for the reprojection error Ew, which may obstruct the calibration of the reconstruction points. Therefore, advantageously, a is low enough to provide a small MSE. For example, α may be within a range of about 1000 to 50000.

### 6. Advantages

The embodiment described above can provide the following advantages.

(6a) In the position measuring apparatus 1 of the present embodiment, at step S110, the processing unit 20 acquires a plurality of sets of images at a plurality of respective time instants, with each set of images simultaneously captured at a respective one of the plurality of time instants from different perspectives so as to include the same captured area. The processing unit 20, at step S120, detects, for each set of images at a respective one of the time instants, correspondence points from the respective images of the set, where the correspondence points are points on respective image planes representing the same three-dimensional position.

The processing unit 20, at step S150, calculates a projection point of each of the correspondence points detected at the respective time instants onto each of the plurality of common planes using the preset camera parameters. For each of all combinations of one of the image planes for each set of images captured at a respective one of time instants and a plurality of common planes set at different depthwise positions in the world coordinate system, the camera parameters represent a correspondence relationship to acquire non-linear mapping from each image plane to each common plane.

The processing unit 20, at steps S160-S180, calculates a point at which a sum of squared distances to a plurality of rays each connecting the projection points of the correspondence point on a respective one of the image planes onto the plurality of common planes is minimized, as a reconstruction point representing a three-dimensional position of the correspondence point.

Unlike the conventional single focus camera models with a pair of projection planes prepared individually for each camera, this configuration eliminates a need for the external parameters describing a positional relationship between the cameras, which can reduce the number of parameters required to calculate the reconstruction points. Further, this configuration only has to deal with the camera parameters corresponding to the internal parameters in the conventional single focus camera models, which can simplify calibration of the camera parameters. This can improve the calculation accuracy of the reconstruction points.

The reconstruction points are calculated using the images at a plurality of time instants, which can improve the calculation accuracy of the reconstruction points as compared to the configuration where the reconstruction points are calculated using the images at a single time instant. In addition, instead of calculating a point at which a sum of squared distances is minimized, a point at which a sum of absolute distance values is minimized.

(6b) In the present embodiment, the non-single focus camera model is used as a camera model.

With this configuration, even in a situation where effects of refraction of rays are included in the captured images, accurate three-dimensional distance measurement can be accomplished.

(6c) In the present embodiment, only two planes H1, H2 common to all the cameras, onto each of which points on an image plane of each camera are projected, are defined in the non-single focus camera model. Therefore, two planes do not have to be provided individually for each camera, such that points on the image plane of the camera are projected onto the two planes.

With this configuration, states or conditions of all the cameras can be described without using the external parameter, which can reduce the number of camera parameters as compared to the single focus camera models requiring the external parameters.

(6d) In the above embodiment, the processing unit 20, at step S210, performs a bundle adjustment to optimize the camera parameters and the reconstruction points and updates the camera parameters before the bundle adjustment to the calibrated camera parameters after the bundle adjustment.

In the present embodiment, the reprojection error Ew is uniquely determined according to the equation (7). Therefore, the bundle adjustment can be applied to calibration of both the set of reconstruction points {RX} and the set of camera parameters {A}. That is, simultaneous calibration of both the set of reconstruction points {RX} and the set of camera parameters {A} can be accomplished. Therefore, for example, even when positions of the cameras have varied due to vibration or the like, the three-dimensional position measurement can be performed while automatically and dynamically correcting for such variations in the camera positions, which allows the three-dimensional position measurement to be continuously performed.

(6e) In the above embodiment, the processing unit 20, at step S210, uses an integral, over all the projection points acquired at the plurality of time instants, of a distance between one of projection points of each un-calibrated reconstruction point onto the common planes and one of reprojection points of each calibrated reconstruction point onto the common planes in a direction of the ray connecting the projection points of the un-calibrated reconstruction point onto the common planes, as an evaluation function used in the bundle adjustment.

In this configuration, an integral, over all the projection points acquired at the plurality of time instants, of a distance between the projection and reprojection points is used as the evaluation function, which can optimize the reconstruction points taking into account all the projection points acquired at the plurality of time instants.

(6f) In the above embodiment, the processing unit 20, at step S210, uses a cost function expressed by a sum of a distance term representing squared distances between the plurality of rays and a parameter term representing variations over time of the camera parameters, as an evaluation function used in the bundle adjustment.

With this configuration, the cost function is used as an evaluation function, which allows the reconstruction points and camera parameters to be determined via simple processing for determining the distance term and the parameter term to minimize the cost.

(6g) In the present embodiment, the processing unit 20, at step S210, defines the parameter term as including higher order terms weighted with a predetermined coefficient and lower order terms weighted with another coefficient lower than the predetermined coefficient.

Variations in the camera parameters due to non-linear distortions caused by a refractor, such as a front windshield, are more liable to appear in the higher order terms than in the lower terms. Variations in the camera parameters caused by motion of the cameras, such as translation or rotation, are more liable to appear in the lower order terms than in the higher order terms. Therefore, in the present embodiment, taking into account the non-linear distortions caused by the refractor more, and to reduce effects of the motion of the cameras, the coefficients of the higher order terms are set higher than the coefficients of the lower order terms.

This configuration enables the calibration taking only the non-linear distortions into account while reducing effects of motion of the cameras.

(6h) In the present embodiment, the processing unit 20, at step S220, calculates a three-dimensional distance to each point on each of the images using the reconstruction points.

With this configuration, for each point on the image, a three-dimensional distance to its reconstruction point can be calculated.

### 7. Modifications

It is to be understood that the invention is not to be limited to the specific embodiment disclosed above and that modifications and other embodiments are intended to be included within the scope of the appended claims.

(7a) In the above embodiment, the camera parameters defined by the equations (2) and (3), that is, a combination of the non-linear transformation based on the Kth-order polynomials and the plane projective transformation, are used. Alternatively, the camera parameters defined in another manner may be used.

(7b) In the above embodiment, the cost used in the bundle adjustment is defined by the equation (9). Alternatively, the cost used in the bundle adjustment may be defined by the following equation (10).

$$\{ \{ A \} , \{ RX \} \} = arg min {\sum }_{t = 1}^{T} ( {{\sum }_{q = 1}^{Q} {E}_{q}^{t} +}_{{\_}_{{unknown}_{points}}} λ {{\sum }_{r = 1}^{R} {E}_{r}^{B , t} +}_{{\_}_{basis points}} α {{\sum }_{k = 1}^{S} \vert {a}_{k}^{t} - {a}_{k}^{t - 1} \vert}_{{\_}_{regularization term}} ) \qquad ( 10 )$$

The equation (10) shows a total cost that is a sum of a term representing a cost for unknown points, a term representing a cost for basis points, and the regularization term set forth above.

The unknown points are points such that their correspondence points on the captured images are known using a SHIFT method or the like, but their three-dimensional positions are unknown. The basis points are points such that their correspondence points on the captured images are known and their three-dimensional positions are also known incorporating a laser radar or the like. Preferably, there are many such basis points and these basis points are different in the depthwise position.

The cost for unknown points may take a default value because positions of the unknown points are unknown. In an alternative, the cost for unknown points may be calculated using an arbitrary technique, for example, using an approximate value depending on a situation. The cost for basis points may be calculated using a similar technique to that used in the above embodiment.

(7c) The functions of a single component may be distributed to a plurality of components, or the functions of a plurality of components may be integrated into a single component. At least part of the configuration of the above embodiments may be replaced with a known configuration having a similar function. At least part of the configuration of the above embodiments may be removed. At least part of the configuration of one of the above embodiments may be replaced with or added to the configuration of another one of the above embodiments. While only certain features of the invention have been illustrated and described herein, many modifications and changes will occur to those skilled in the art. It is, therefore, to be understood that the appended claims are intended to cover all such modifications and changes as falling within the true spirit of the invention.

(7d) The present disclosure is not limited to the above-described position measuring apparatus. The present disclosure may be implemented in various forms, such as a system including the above-described position measuring apparatus, programs enabling a computer to serve as the above-described position measuring apparatus, a non-transitory, tangible computer-readable storage medium storing these programs, and a position measuring method.

What is claimed is:

1. A position measuring apparatus comprising:
an image acquirer configured to acquire a plurality of sets of images at a plurality of respective time instants, each set of images being simultaneously captured at a respective one of the plurality of time instants from different perspectives so as to include the same captured area;
a correspondence point detector configured to detect, for each set of images at a respective one of the time instants, correspondence points from the respective images of the set, the correspondence points being points on respective image planes representing the same three-dimensional position;
a projection point calculator configured to calculate a projection point of each of the correspondence points detected at the respective time instants onto each of a plurality of common planes set at different depthwise positions in a world coordinate system using preset camera parameters, the camera parameters representing a correspondence relationship to acquire non-linear mapping from each image plane to each common plane for each of all combinations of one of the image planes for each set of images captured at a respective one of the time instants and the plurality of common planes; and
a reconstruction point calculator configured to calculate a point at which distances to a plurality of rays each connecting the projection points of the correspondence point on a respective one of the image planes onto the plurality of common planes are minimized, as a reconstruction point representing a three-dimensional position of the correspondence point.

2. The apparatus according to claim 1, further comprising a calibrator configured to perform a bundle adjustment to optimize the camera parameters and the reconstruction points calculated by the reconstruction point calculator and update the camera parameters before the bundle adjustment to the calibrated camera parameters after the bundle adjustment.

3. The apparatus according to claim 2, wherein the calibrator is configured to use an integral, over all the projection points acquired at the plurality of time instants, of a distance between one of projection points of each un-calibrated reconstruction point onto the common planes and one of reprojection points of each calibrated reconstruction point onto the common planes in a direction of the ray connecting the projection points of the un-calibrated reconstruction point onto the common planes, as an evaluation function used in the bundle adjustment.

4. The apparatus according to claim 2, wherein the calibrator is configured to use a cost function expressed by a sum of a distance term representing distances for the plurality of rays and a parameter term representing variations over time of the camera parameters, as an evaluation function used in the bundle adjustment.

5. The apparatus according to claim 4, wherein the calibrator is configured to define the parameter term as including higher order terms weighted with a predetermined coefficient and lower order terms weighted with another coefficient lower than the predetermined coefficient.

6. The apparatus according to claim 1, further comprising a distance calculator configured to calculate a three-dimensional distance to a point on the images using the reconstruction points.

7. A position measuring apparatus comprising:
an image acquirer configured to acquire a plurality of sets of images at a plurality of respective time instants, each set of images being simultaneously captured at a respective one of the plurality of time instants from different perspectives so as to include the same captured area;
a correspondence point detector configured to detect, for each set of images at a respective one of the time instants, correspondence points from the respective images of the set, the correspondence points being points on respective images representing the same three-dimensional position;
a projection point calculator configured to calculate a projection point of each of the correspondence points detected at the respective time instants as viewed from the different perspectives onto each of a plurality of common planes set at different depthwise positions in a world coordinate system; and
a reconstruction point calculator configured to calculate a length between each of the projection points and a corresponding one of lines defined as viewed from the different perspectives at each of the time instants and determine the three-dimensional position depending on the calculated lengths at the respective time instants.

8. The apparatus according to claim 7, wherein the reconstruction point calculator is configured to determine the three-dimensional position such that the calculated lengths at the respective time instants are minimized.
